(19) United States
(12) Patent Application Publication
(10) Pub. No.: US 2019/0080062 A1
(43) Pub. Date: Mar. 14, 2019

(54) CLIENT CALL VALIDITY ENFORCEMENT FOR MICROSERVICES

(71) Applicant: Coursera Inc., Mountain View, CA (US)

(72) Inventor: Eric EASLEY, San Francisco, CA (US)

(21) Appl. No.: 15/703,444

(22) Filed: Sep. 13, 2017

(51) Int. Cl. G06F 21/31; H04W 12/06; H04L 29/06

(52) U.S. Cl. CPC G06F 21/313; H04L 63/08; H04W 12/06

(57) ABSTRACT

Techniques described herein provide for consistent and efficient construction of modularized software applications, using microservices. Microservice clients configured to call resources of available microservices may be constructed using a publicly exposed client constructor, thereby resulting in the microservice clients utilizing a resource mapping in which available microservices are mapped to their respective, included resources. In this way, straightforward testing techniques may be utilized to ensure that all constructed clients request resources that are actually and correctly associated with specified microservices being called.

### TECHNICAL FIELD

This description relates to software applications built using microservices.

### BACKGROUND

Various types of modularized software applications may be constructed according to a number of known techniques. That is, while it is possible to construct a software application as a large, monolithic application that is designed to provide all desired functionality for a given context, such approaches often result in software applications that are difficult to construct, test, deploy, and maintain. Therefore, it is often desirable to modularize specific functions into discrete services or other components, and then provide desired functionalities through different combinations of the services.

Unfortunately, errors may occur when combining such services or other modules/components to obtain a desired result. For example, one service, e.g., a microservice, may be programmed to act as a client to a second service, and request a specific output from the second service. If the second service is not configured to provide the specific output, however, then the service/client will not be able to proceed correctly, resulting in an error. Moreover, such errors may not be discovered until following a deployment to users, which means that the users will experience the errors and any associated inconveniences.

### SUMMARY

Accordingly, techniques described herein provide an assurance that any microservice requesting a resource of a second microservice will do so through the context of a resource mapping that maps each resource to its corresponding microservice. In other words, any microservice acting as a client of a second microservice will issue its request (e.g., client call) using available terminology of the resource mapping. Then, through correspondence of the resources with their associated microservice within the resource mapping, it is possible to ensure and enforce that all microservice calls for resources that are available at a called microservice will be constructed correctly, and ultimately fulfilled. More specifically, it is straightforward and convenient to test such client calls during a testing phase, to identify and correct any related errors prior to deployment.

More generally, for example, within a distributed, service-oriented architecture, many separate services must communicate over the network for a larger content platform to function. In each such instance of inter-service communication, a client (the service making a request for data) and a server (the service that receives the request and returns data) must communicate. It is possible for these disparate services to become incoherent, since, for example, coherence requires a precise correspondence of services, functionality (endpoints), and versions.

For example, in an online learning scenario, a service responsible for managing course enrollments may make a request for data (acting as a client) on a specific user of the online learning content platform, only to find when making a network request to the user service (acting as the server) that the expected functionality does not exist therein.

Techniques described herein provide an analysis and refactoring program(s) to extract and reincorporate information about inter-service clients. In particular, the resulting data enables precise knowledge as to what clients expect of servers in terms of service name, functionality (endpoint) and version. This information may then be combined and compared with existing declarations of server name, functionality and version, to thereby ensure correspondence.

As a result, correspondence may be ensured through automated tests, which do not require the writing of manual tests on a point-by-point basis, which thus ensure that the appropriate backing functionality at the appropriate version exists in the appropriate service for all client calls. As a result, assuming such automated tests are passed, failed client-server calls of the kind described above should not be experienced during production.

The described techniques may be valuable in a variety of contexts. For example, the techniques may be valuable when writing new client functionality, testing existing functionality, or when transferring/reorganizing functionality among services.

The above-referenced example implementations may also be implemented as corresponding, methods, systems, or devices. Further, the details of these and other implementations are set forth in the accompanying drawings and the description below. Other features will be apparent from the description and drawings, and from the claims.

### BRIEF DESCRIPTION OF THE DRAWINGS

FIG. 1 is a block diagram of a system for client call validity enforcement for microservices.

FIG. 2 is a flowchart illustrating example operations of the system of FIG. 1.

FIG. 3 is a flowchart illustrating more detailed example testing operations of FIGS. 1 and 2.

### DETAILED DESCRIPTION

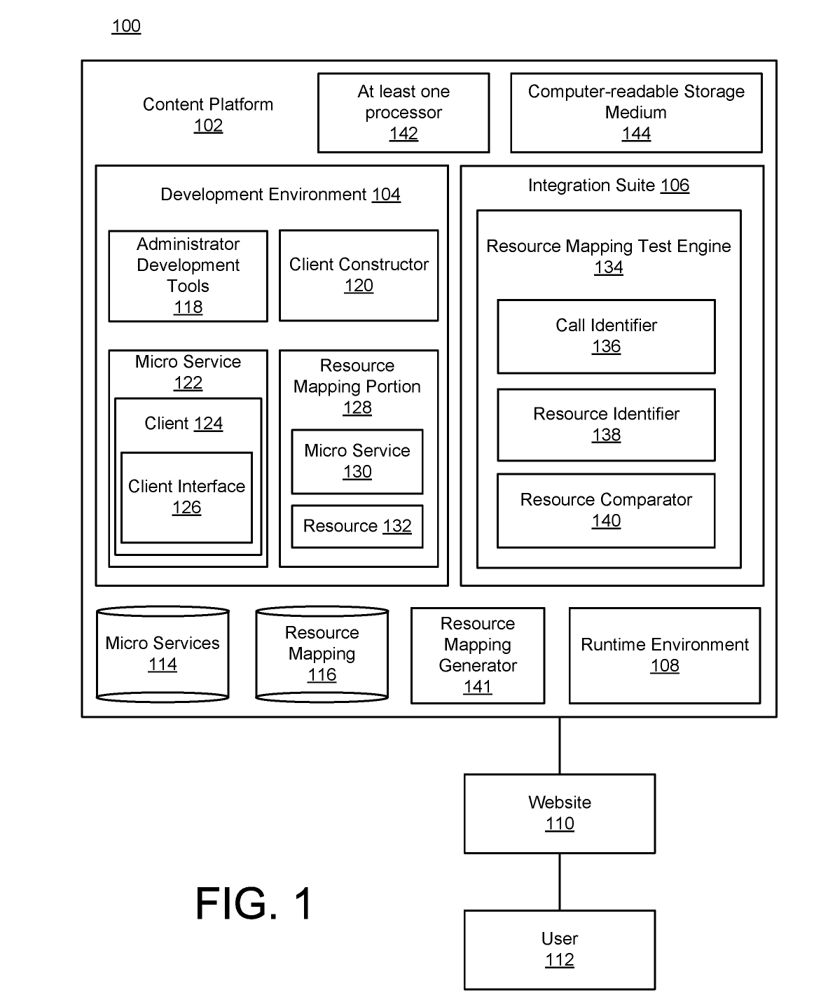

FIG. 1 is a block diagram of a system 100 for client call validity enforcement for microservices. In the example of FIG. 1, a content platform 102 is illustrated as including a development environment 104, an integration suite 106, and a runtime environment 108. Using the content platform 102, a website 110 may be provided to a user 112, to thereby provide the user 112 with various desired website features, or other software application features, in an efficient and reliable manner.

More particularly, as described in detail below, the development environment 104 may be utilized to develop a plurality of microservices 114, where each such microservice includes one or more resources used, e.g., to provide functionality for the website 110. In order to ensure that resources of the various microservices 114 are correctly and completely associated with corresponding microservices, a resource mapping 116 may be constructed and utilized. In the present description, the term microservices should be understood to represent any appropriate, suitable, or corresponding service or other modularized software component.

As also described in more detail below, the resource mapping 116 thus provides an association between each microservice and its corresponding resources, so that this association may be relied upon by developers utilizing the development environment 104, and may be tested for validity by users of the integration suite 106. In this way, once specific services, applications, or other features of the website 110 are deployed to the runtime environment 108, users of the content platform 102 may be assured that the various desired features of the website 110 will be provided in a reliable manner. Moreover, developers utilizing the development environment 104 and the integration suite 106 will be provided with a straightforward, efficient environment for development and testing.

In the example of FIG. 1, the development environment 104 is illustrated as including administrator tools 118. In the example, it is assumed that the content platform 102 is accessed and utilized by a potentially large number of software developers tasked with providing the website 110. In order to provide and enforce uniformity, convenience, and other advantages in the work of these software developers, the administrator development tools 118 may be utilized to enable authorized administrators to provide tools and other techniques to be used by the software developers. In particular, as described in detail herein, the administrator development tools 118 may be utilized to provide (e.g., publicly expose) a privately-constructed client constructor 120 that enables construction of a client 124 within a microservice 122.

More particularly, the client constructor 120 is provided in a manner that is configured to construct the client 124 with a client interface 126 that references, and utilizes, a resource mapping portion 128 of the resource mapping 116, in order to identify and access a microservice 130 and its associated resource 132. In other words, in the example of FIG. 1, the development environment 104 is configured to develop a microservice 122 that leverages and otherwise utilizes one or more existing microservices of the microservices 114, including, e.g., the microservice 130. In this way, for example, the microservice 122 and its client 124 may be utilized to provide combinations of existing microservice resources to be deployed within the runtime environment 108, and provided to the user 112 via the website 110.

For example, in the various following examples, the content platform 102 and the website 110 are described in the context of an online learning scenario, in which the microservices 114 are designed to provide specific functionalities that are of use when providing online learning experiences for the user 112, where the user 112 may represent, for example, a teacher and/or a student. In these examples, then, a first microservice of the microservices 114 may represent a service for delivering content to a student, while a second microservice may be configured to provide registration and authorization resources for onboarding and authenticating students, and a third microservice may be configured to provide resources associated with payments submitted by students.

More generally, it will be appreciated from the present description that the microservices 114 represent a modularized approach to constructing and providing the website 110. In other words, rather than providing a single, monolithic application that provides all of the content delivery, onboarding, and payment functionalities just referenced (and many other functionalities), the use of the microservices 114 enables developers using the development environment 104 to construct, e.g., a new microservice, such as the microservice 122, in a manner that leverages (e.g., combines) existing microservices, to thereby enable and provide new, additional functionality for the website 110, in an efficient and reliable manner.

At the other extreme from the type of single, monolithic application just referenced, it is also theoretically possible to develop microservices that each provides only a single resource; however, such an approach may prove to be logistically difficult, and advantages obtained from combining such microservices may be outweighed by the overhead of implementing the various interactions there between.

In the example of FIG. 1, as referenced above and described in detail below, the microservices 114 are constructed in a manner that seeks to optimize the use of existing microservices and associated resources, without incurring an impractical level of logistical difficulties and associated overhead. In particular, each microservice of the microservices 114 may include a plurality of resources that are heavily correlated or associated with one another.

In such scenarios, nonetheless, it may be difficult or impractical for individual developers using the development environment 104 to remember or otherwise determine exactly which microservice is associated with specific, corresponding resources. As a result, it may occur that a developer constructing the microservice 122 may erroneously construct the client 124, such as by erroneously instructing the client 124 to access a resource that is not actually included within a specified service.

For example, the developer might construct the microservice 122 as including the client 124 being constructed to request an authentication functionality from a payment microservice, rather than from a registration microservice. If the resulting microservice were compiled and deployed within the runtime environment 108, then the user 112 may later experience an error when using the website 110 to execute an authentication request.

Although it is possible in conventional systems to attempt to provide and execute software testing to identify such errors, such tests are often highly individual or specific to the microservices and associated resources being utilized, so that such testing is burdensome, and prone to error. Moreover, even if such testing techniques are successful, developers may still experience the burden and difficulty of attempting to leverage the existing microservices in such environments, as well as the inconvenience of correcting associated errors once identified by such testing. Moreover, when such conventional tests do fail, the resulting microservice deployed to the runtime environment 108 is utilized by the user 112 in the context of the website 110, and, as referenced above, may result in the user 112 experiencing an error message or other inconveniences associated with use of the website 110.

In contrast, in the example of FIG. 1, the client constructor 120 and the resource mapping 116, among other features of the system 100, ensure that the client 124 is constructed with the client interface 126, and utilizes the resource mapping portion 128 of the resource mapping 116 to correctly and completely identify the service 130 as being associated with the desired resource 132. For example, as referenced above and described in more detail below, the administrator development tools 118 may be utilized to provide the client constructor 130 as a private type that is the only publicly exposed constructor provided to developers using the development environment 104. Accordingly, if the developers wish to utilize an instance of the client constructor 120 to generate a corresponding instance as the client 124, the only available methodology is to use the constructor function of the client constructor 120, which demands a corresponding resource mapping (e.g., the resource mapping portion 128) of the resource mapping 116.

Once the microservice 122 has been constructed, the integration suite 106 may be utilized to test the microservice 122 before permitting its deployment within the runtime environment 108. In particular, it will be appreciated that, although not explicitly illustrated in the simplified example of FIG. 1, the microservice 122 may include two or more clients, each of which may call a corresponding resource of an identified microservice of the microservices 114, so that the microservice 122 ultimately provides desired combinations of such resources. Thus, the integration suite 106 should be understood to provide various functionalities associated with integrating such resources within the context of the microservice 122. For the purposes of the simplified example of FIG. 1, however, the microservice 122 is illustrated as having only the single client 124 accessing the single microservice 130 and associated resource 132, so that various functionalities associated with integration operations of the integration suite 106 are not described here in detail.

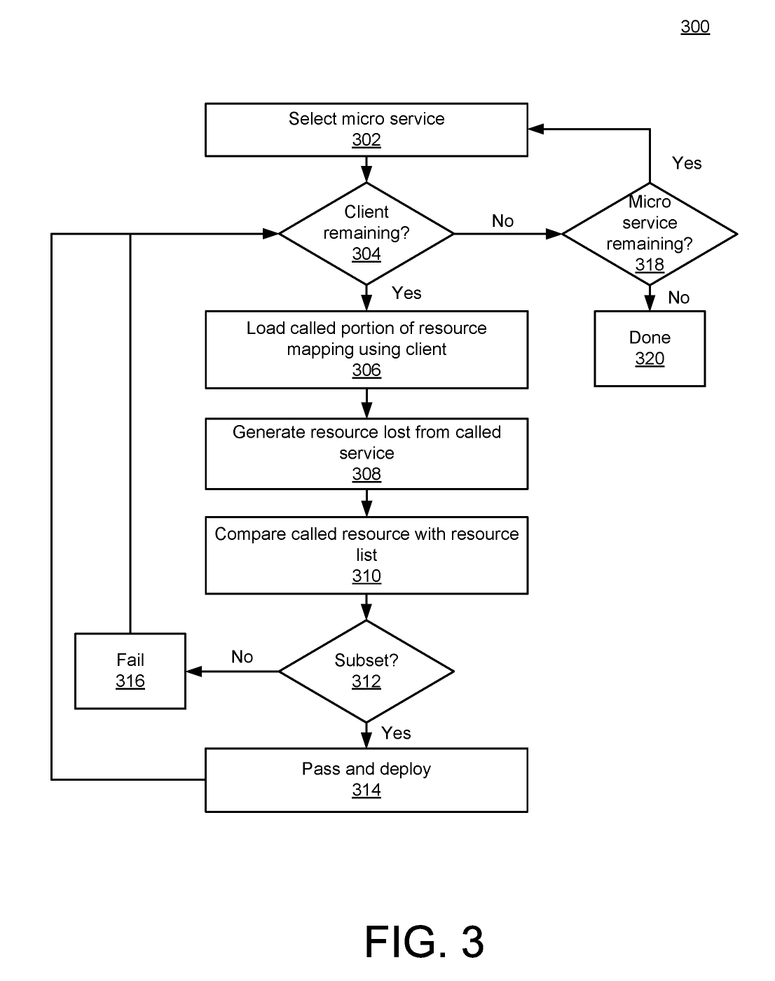

Instead, a resource mapping test engine 134 is illustrated, which is configured to test the microservice 122 and ensure that the client 124, and any other clients of the microservice 122, correctly and completely identifies desired resources and corresponding microservices. Again, for the purposes of the simplified example of FIG. 1, operations of the resource mapping test engine 134 are described only with respect to the client 124, but should be understood to represent corresponding operations for multiple such clients (as described in detail below, with respect to FIG. 3).

In the example of FIG. 1, the resource mapping test engine 134 includes a call identifier 136 that is configured to analyze the client interface 126 and the resource mapping portion 128 to determine all called resources and associated microservices. In other words, the call identifier 136 is configured to determine the requested resources that are expected by the client 124 to exist at a corresponding microservice.

Meanwhile, a resource identifier 128 of the resource mapping test engine 134 may be configured to interact with the microservices 114 to determine, for a particular microservice, which resources that microservice identifies as being associated therewith. For example, the microservices 114 may each be constructed with an advertisement or content description functionality that responds to requests with a listing of resources provided. For example, the microservice 130 may provide a number of resources, including the resource 132, and may be configured to respond to the resource identifier 128 with a listing of all such included resources.

Then, a resource comparator 140 of the resource mapping test engine 134 may be configured to compare the resources identified by the call identifier 136 with the resources identified by the resource identifier 138, and thereby determine that resources of the former are a subset of resources included in the latter. In other words, in the example, the resource comparator 140 will determine that the resource 132 is included within the total list of resources provided by the microservice 130.

In this way, the resource mapping test engine 134 validates and verifies that the client 124 has requested resources that actually exist at specified, corresponding microservices. Accordingly, scenarios in which calls are moved to microservices for resources that do not actually exist therein may be avoided, and features and functions of the website 110 may be deployed within the runtime environment 108 in a more reliable manner. Moreover, it will be appreciated that the resource mapping test engine 134 is configured in a uniform, widely-applicable manner, so that associated tests may be easily performed for all manners and types of the microservice 122, and the various microservices 114. In other words, a single test may be utilized to test a number of different microservices and associated clients, rather than being required to construct individual tests differently for individual clients. As a result, burdens on software developers utilizing the content platform 102 may be reduced, and features of the website 110 may be provided quickly and efficiently.

In the example of FIG. 1, the resource mapping 116 may be constructed using one or more of a variety of techniques, generally associated with a resource mapping generator 141. For example, the resource mapping generator 141 may represent a code refactoring script that is configured to analyze a code base of the existing microservices 114, and identify and determine an exhaustive list of all included client calls contained therein. The resource mapping generator 141 also may interact directly with the microservices 114 to determine which resources are advertised by each microservice as being included therein. In additional or alternative implementations, the resource mapping generator 141 may be utilized by software developers in conjunction with developing the microservices 114 originally, such as when the developers update the resource mapping 116 to reflect or include resources of a newly-added microservice.

In other words, for example, a resource mapping generator 141 may be implemented retroactively on an existing code base of microservices and included clients, through the use of the code refactoring script that identifies and maps all included client calls to specified resources. In such scenarios, the code refactoring script also may refactor client code of existing clients, so that the existing clients are updated to utilize the client constructor 120. Additionally, or alternatively, as new microservices are developed, the resource mapping 116 may be updated in an ongoing manner, so that the resource mapping 116 is consistently kept complete and accurate by all developers using the development environment 104.

In this way, it is possible to scan an existing code base (e.g., including the microservices 114) including at least one microservice having at least one microservice client constructed without using the client constructor 120. Then, by generating a listing of client calls for microservice resources made by the at least one microservice client constructed without using the client constructor 120, at least a portion of the resource mapping 116 may be generated, based on the listing. Subsequently, the at least one client constructed without using the client constructor 120 may be updated, to thereby replace an existing client interface thereof with an updated client interface constructed using the client constructor 120

In the example of FIG. 1, the content platform 102 is illustrated as being executed using at least one processor 142, and a non-transitory computer readable storage medium 144. That is, instructions stored on the computer readable storage medium 144 may be executed by the at least one processor 142, in order to thereby provide, e.g., the development environment 104, the integration suite 106, and the runtime environment 108. In practice, the content platform 102 may represent a plurality of servers and associated databases, which may be configured for remote access by the various administrators and software developers.

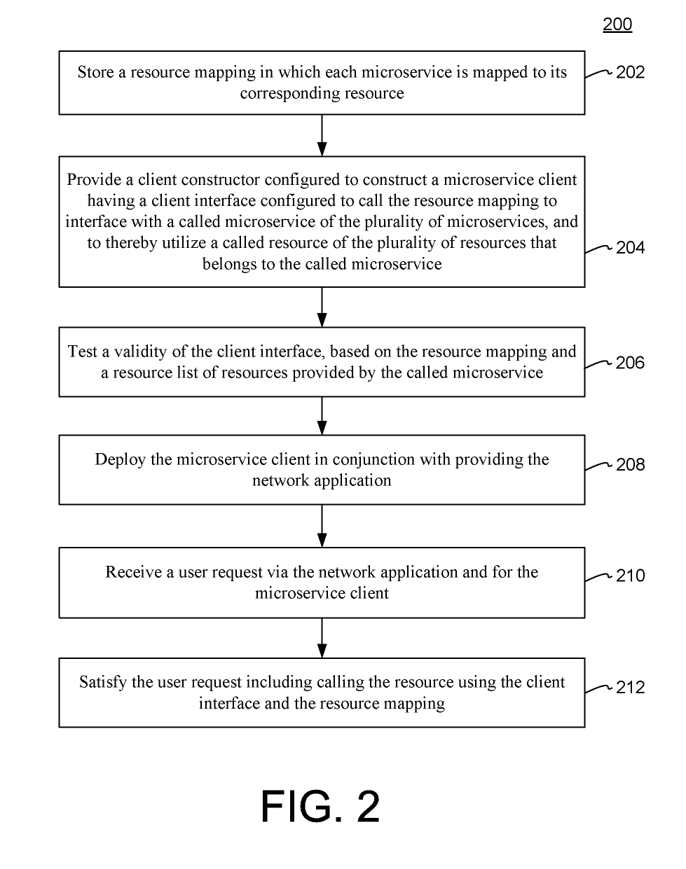

FIG. 2 is a flowchart illustrating example operations of the system 100 of FIG. 1. In the example of FIG. 2, operations 202-212 are illustrated as separate, sequential operations. However, it will be appreciated that, in additional or alternative implementations, any two or more of the operations 202-212 may be implemented in a partially or completely overlapping or parallel manner, or in a nested, iterative, looped, or branched fashion. Moreover, in all such implementations, it may occur that one or more additional or alternative operations or sub-operations are included, and/or one or more operation or sub-operation may be omitted.

In the example of FIG. 2, it will be appreciated from the above description of FIG. 1, a network application, such as may be provided in conjunction with the website 110, is constructed and/or provided using a plurality of interacting microservices, each microservice including a plurality of resources, as described above with respect to the microservices 114.

In the example of FIG. 2, a resource mapping is stored in which each microservices is mapped to its corresponding resource (202). For example, the resource mapping generator 141 may be configured to generate or otherwise provide the resource mapping 116, as referenced above in the context of FIG. 1. In practice, for example, the resource mapping 116 may implement any acceptable technique for pairing or otherwise associating two pieces of data, such as a resource and its associated microservice. Such a tuple may be stored, for example, using a key value map, in which a key represents a resource, and a corresponding value represents a microservice to which the resource belongs. Of course, any suitable technique for pairing the resources and services may be used, such as, e.g., a dictionary, or an association list.

A client constructor may be provided to construct a microservice client having a client interface configured to call the resource mapping to interface with a called microservice of the plurality of microservices, and to thereby utilize a called resource of the plurality of resources that belongs to the called microservice (204). For example, the client constructor 120 may be provided, to be utilized by a software developer using the development environment 104 to create the microservice 122, including instantiating the client 124 and its client interface 126. As described herein, the client constructor 120 may be provided as the only publicly-exposed constructor that is exposed by the administrator development tools 118, so that the client interface 126 is restricted to referencing resources with microservices 114 only by way of the resource mapping 116. For example, the resource mapping portion 128 may be specified by the client interface 126, to thereby identify the mapping of the microservice 130 and the resource 132.

A validity of the client interface may be tested, based on the resource mapping and a resource list of resources provided by the called service (206). For example, the resource mapping test engine 134 may be configured to test the validity of the client interface 126, based on the resource mapping portion 128 and a resource list obtained from the microservices 114. Specifically, as described, the call identifier 136 may be configured to load the resource mapping portion 128 representing the resources expected by the client 124 to exist, while the resource identifier 138 may interact with the microservices 114 to obtain the resource list of all associated resources of identified microservices. Finally, the resource comparator 140 may be configured to determine that the output of the call identifier 136 is a subset of the output of the response resource identifier 138, i.e., that all expected resources are correctly and completely included within corresponding, specified microservices.

The microservice client may even be deployed in conjunction with providing the network application (208). For example, the microservice 122 may be compiled and deployed, including the client 124, within the runtime environment 108, in order to provide the website 110, or corresponding network application.

A user request may be received via the network application and for the microservice client (210). For example, the user 112 may submit a request to the website 110 that requires the client 124 to call the resource 132 of the microservice 130.

The user request may be satisfied, including calling the resource using the client interface and the resource mapping (212). For example, the deployed microservice 122 and client 124 may execute the necessary code path to access the specified resource mapping and thereby obtain and provide the resource 132, via the website 110, to the user 112.

FIG. 3 is a flowchart 300 illustrating more detailed example operations of the system 100 of FIG. 1. More particularly, the flowchart 300 of FIG. 3 illustrates more detailed example implementations of the resource mapping test engine 134, corresponding to the operation 206 of FIG. 2.

In the example of FIG. 3, it is assumed that the development environment 104 has been utilized to construct one or more microservices, including the microservice 122, each of which may have two or more clients, each of which may itself be configured to call a resource of another microservice, via the resource mapping 116. Thus, in FIG. 3, the resource mapping test engine 134 initially selects a microservice from among the plurality of microservice (302).

Assuming that the selected microservice has at least one client remaining to be test (304), the call identifier 136 of the resource mapping test engine 134 may proceed to load the called portion of the resource mapping associated with the selected client (306).

The resource identifier 138 may then proceed to generate a resource list of all resources provided by each relevant microservice (308). In this way, the resource comparator 140 may execute a comparison of the called resources with the generated resource list (310).

If the called resources represent a subset of the resource list (312), then the tested client may be considered to have passed the testing and to be ready for a deployment (314), at which point a subsequent client may be tested, if any client is remaining (304). If the called resources do not represent a subset of the resource list (312), then the test has failed (316). In the event of such failure, appropriate messages may be generated to alert the developer of the failure, or to otherwise correct the error.

Once no further clients of the microservice being tested are remaining (310), then any remaining microservice requiring testing may be considered (318). If further microservices are remaining, then operations 302-316 of FIG. 3 may proceed as described above. Otherwise, the testing process is completed (320).

The following code portions provide example, non-limiting techniques for implementing various ones of the functionalities described above. For example, code portion 1 illustrates a technique for listing services, in which each service is an instance of a defined type:

Code Portion 1

object CourServiceName extends Enum[CourServiceName] {

case object analytics extends CourServiceName

As shown, and as discussed above, code portion 1 illustrates that “analytics” is a service that may be instantiated.

Code portion 2 illustrates construction of a private class for the resource mapping 116 of FIG. 1, in which a service is mapped to its corresponding resource(s).

Code Portion 2

class ResourceMapping private (

val service: CourServiceName,
val resource: ResourceName,

object ResourceMapping extends Enum[ResourceMapping] {
import CourServiceName._{—}
private def apply(service: CourServiceName, resource:

ResourceName): ResourceMapping = {

new ResourceMapping(service, resource)

}

Code portion 3 illustrates an example portion of a resource mapping, such as the resource mapping portion 128 of FIG. 1. In the example, the microservice “analytics” is mapped to a plurality of associated resources, such as surveys.

Code Portion 3

case object surveys extends

ResourceMapping(analytics, ResourceName(“surveys”, 1))

case object surveyResponses extends

ResourceMapping(analytics, ResourceName(“surveyResponses”, 1))

case object surveySectionResponses extends

ResourceMapping(analytics, ResourceName(“surveySectionResponses”, 1))

case object taskAuthorizationList extends

ResourceMapping(analytics, ResourceName(“taskAuthorizationList”, 1))

case object aliceMessages extends

ResourceMapping(analytics, ResourceName(“aliceMessages”, 1))

case object quickQuestionsCampaign extends

ResourceMapping(analytics, ResourceName(“quickQuestionsCampaign”, 1))

Code portion 4 provides an example of the privately-constructed, publicly-available client constructor 120 of FIG. 1.

Code Portion 4

trait ServiceResourceClientFactory {

def newServiceResourceClient[K, M](

serviceResource: ResourceMapping,
requiredFields: List[String] = List.empty)
(implicit bodyFormat: OFormat[M],

keyFormat: KeyFormat[K]):

AuthenticatingClient[ResourceClient[K, M]] = {

newClient(

StringKey(serviceResource.service).key,
serviceResource.resource.topLevelName,
serviceResource.resource.version,
requiredFields)

}

Implementations of the various techniques described herein may be implemented in digital electronic circuitry, or in computer hardware, firmware, software, or in combinations of them. Implementations may be implemented as a computer program product, i.e., a computer program tangibly embodied in an information carrier, e.g., in a machine-readable storage device, for execution by, or to control the operation of, data processing apparatus, e.g., a programmable processor, a computer, or multiple computers. A computer program, such as the computer program(s) described above, can be written in any form of programming language, including compiled or interpreted languages, and can be deployed in any form, including as a stand-alone program or as a module, component, subroutine, or other unit suitable for use in a computing environment. A computer program can be deployed to be executed on one computer or on multiple computers at one site or distributed across multiple sites and interconnected by a communication network.

Method steps may be performed by one or more programmable processors executing a computer program to perform functions by operating on input data and generating output. Method steps also may be performed by, and an apparatus may be implemented as, special purpose logic circuitry, e.g., an FPGA (field programmable gate array) or an ASIC (application-specific integrated circuit).

Processors suitable for the execution of a computer program include, by way of example, both general and special purpose microprocessors, and any one or more processors of any kind of digital computer. Generally, a processor will receive instructions and data from a read-only memory or a random access memory or both. Elements of a computer may include at least one processor for executing instructions and one or more memory devices for storing instructions and data. Generally, a computer also may include, or be operatively coupled to receive data from or transfer data to, or both, one or more mass storage devices for storing data, e.g., magnetic, magneto-optical disks, or optical disks. Information carriers suitable for embodying computer program instructions and data include all forms of non-volatile memory, including by way of example semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory may be supplemented by, or incorporated in special purpose logic circuitry.

To provide for interaction with a user, implementations may be implemented on a computer having a display device, e.g., a cathode ray tube (CRT) or liquid crystal display (LCD) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input.

Implementations may be implemented in a computing system that includes a back-end component, e.g., as a data server, or that includes a middleware component, e.g., an application server, or that includes a front-end component, e.g., a client computer having a graphical user interface or a Web browser through which a user can interact with an implementation, or any combination of such back-end, middleware, or front-end components. Components may be interconnected by any form or medium of digital data communication, e.g., a communication network. Examples of communication networks include a local area network (LAN) and a wide area network (WAN), e.g., the Internet.

While certain features of the described implementations have been illustrated as described herein, many modifications, substitutions, changes and equivalents will now occur to those skilled in the art. It is, therefore, to be understood that the appended claims are intended to cover all such modifications and changes as fall within the scope of the embodiments.

What is claimed is:

1. A computer program product, the computer program product being tangibly embodied on a non-transitory computer-readable storage medium and comprising instructions that, when executed, are configured to cause at least one computing device to provide a network application using a plurality of microservices interacting with one another, each microservice including a plurality of resources, wherein the instructions, when executed, are configured to:
store a resource mapping in which each microservice is mapped to its corresponding resource;
provide a client constructor configured to construct a microservice client having a client interface configured to call the resource mapping to interface with a called microservice of the plurality of microservices, and to thereby utilize a called resource of the plurality of resources that belongs to the called microservice; and
test a validity of the client interface, based on the resource mapping and a resource list of resources provided by the called microservice.

2. The computer program product of claim 1, wherein the instructions, when executed, are further configured to:
deploy the microservice client in conjunction with providing the network application;
receive a user request via the network application and for the microservice client; and
satisfy the user request including calling the resource using the client interface and the resource mapping.

3. The computer program product of claim 1, wherein the instructions, when executed, are further configured to test the validity of the client interface including:
loading a portion of the resource mapping that includes the called microservice;
retrieving, from the called microservice, the resource list as provided by the called service; and
verifying, including comparing the portion of the resource mapping with the resource list, that the called resource is included within the resource list.

4. The computer program product of claim 1, wherein the instructions, when executed, are further configured to:
store the resource mapping including key-value pairs in which a key represents the resource, and a corresponding value represents the microservice to which the resource belongs.

5. The computer program product of claim 1, wherein the instructions, when executed, are further configured to:
scan an existing code base including at least one microservice having at least one microservice client constructed without using the client constructor;
generate a listing of client calls for microservice resources made by the at least one microservice client constructed without using the client constructor; and
construct at least a portion of the resource mapping based on the listing.

6. The computer program product of claim 5, wherein the instructions, when executed, are further configured to:
update the at least one client constructed without using the client constructor, to thereby replace an existing client interface thereof with an updated client interface constructed using the client constructor.

7. The computer program product of claim 1, wherein the network application includes a website that is part of an online learning content platform.

8. The computer program product of claim 1, wherein the client constructor is privately-constructed and is the only client constructor that is publicly exposed to developers within a development environment for the network application.

9. A method for providing a network application using a plurality of microservices interacting with one another, each microservice including a plurality of resources, the method comprising:
storing a resource mapping in which each microservice is mapped to its corresponding resource;
providing a client constructor configured to construct a microservice client having a client interface configured to call the resource mapping to interface with a called microservice of the plurality of microservices, and to thereby utilize a called resource of the plurality of resources that belongs to the called microservice; and
testing a validity of the client interface, based on the resource mapping and a resource list of resources provided by the called microservice.

10. The method of claim 9, further comprising:
deploying the microservice client in conjunction with providing the network application;
receiving a user request via the network application and for the microservice client; and
satisfying the user request including calling the resource using the client interface and the resource mapping.

11. The method of claim 9, further comprising:
loading a portion of the resource mapping that includes the called microservice;
retrieving, from the called microservice, the resource list as provided by the called service; and
verifying, including comparing the portion of the resource mapping with the resource list, that the called resource is included within the resource list.

12. The method of claim 9, further comprising:
storing the resource mapping including key-value pairs in which a key represents the resource, and a corresponding value represents the microservice to which the resource belongs.

13. The method of claim 9, further comprising:
scanning an existing code base including at least one microservice having at least one microservice client constructed without using the client constructor;
generating a listing of client calls for microservice resources made by the at least one microservice client constructed without using the client constructor; and
constructing at least a portion of the resource mapping based on the listing.

14. The method of claim 13, further comprising:
updating the at least one client constructed without using the client constructor, to thereby replace an existing client interface thereof with an updated client interface constructed using the client constructor.

15. The method of claim 9, wherein the network application includes a website that is part of an online learning content platform.

16. The method of claim 9, wherein the client constructor is privately-constructed and is the only client constructor that is publicly exposed to developers within a development environment for the network application.

17. A computer program product, the computer program product being tangibly embodied on a non-transitory computer-readable storage medium and comprising instructions that, when executed, are configured to cause at least one computing device to:
store a resource mapping in which each microservice is mapped to its corresponding resource;
provide a client constructor configured to construct a microservice client having a client interface configured to call the resource mapping to interface with a called microservice of the plurality of microservices, and to thereby utilize a called resource of the plurality of resources that belongs to the called microservice;
deploy the microservice client in conjunction with providing the network application;
receive a user request via the network application and for the microservice client; and
satisfy the user request including calling the resource using the client interface and the resource mapping.

18. The computer program product of claim 17, wherein the instructions, when executed, are further configured to:
test a validity of the client interface, based on the resource mapping and a resource list of resources provided by the called microservice.

19. The computer program product of claim 18, wherein the instructions, when executed, are further configured to test the validity of the client interface including:
loading a portion of the resource mapping that includes the called microservice;
retrieving, from the called microservice, the resource list as provided by the called service; and
verifying, including comparing the portion of the resource mapping with the resource list, that the called resource is included within the resource list.

20. The computer program product of claim 17, wherein the network application includes a website that is part of an online learning content platform.
